(19) United States
(12) Patent Application Publication
(10) Pub. No.: US 2014/0195532 A1
(43) Pub. Date: Jul. 10, 2014

(54) COLLECTING DIGITAL ASSETS TO FORM A SEARCHABLE REPOSITORY

(71) Applicant: INTERNATIONAL BUSINESS MACHINES CORPORATION, Armonk, NY (US)

(72) Inventors: Vijay Dheap, Chapel Hill, NC (US); Michael D. Whitley, Durham, NC (US)

(73) Assignee: International Business Machines Corporation, Armonk, NY (US)

(21) Appl. No.: 13/737,977

(22) Filed: Jan. 10, 2013

(51) Int. Cl. G06F 17/30

(52) U.S. Cl. CPC G06F 17/30312
USPC 707/736

(57) ABSTRACT

A digital asset is identified, and a copy of the digital asset to store in a repository. Program code tokenizes plaintext into a grammar, wherein the plaintext is associated with the digital asset. If the digital asset is an image the program code is instructed to identify colors and shapes within the image, and also relationships between the image and other digital assets stored in the repository. Contextual information corresponding to the digital asset is generated by utilizing the plaintext that is tokenized into the grammar, wherein the contextual information includes parameter values representing the colors, shapes, and relationships identified. The repository is queried to retrieve one or more copies of other digital assets having contextual information that matches with the contextual information corresponding to the digital asset that is identified. The computer annotates the copy of the digital asset within the repository to form searchable metadata.

### BACKGROUND

1. Field of the Invention

The present invention relates generally to digital asset management, and more specifically to extracting, annotating, and cataloging digital assets from electronic documents, electronic messages, and web content in an automated fashion to form a searchable asset repository.

2. Description of the Related Art

Within a business organization, numerous electronic documents, electronic messages, and web content are created on a daily basis. The electronic documents, electronic messages, and web content can include not only plaintext but also one or more other forms of digital assets such as images, diagrams, flowcharts, video, and audio. The ability to keep track and reuse the digital assets within a large organization and even in a small organization can be a challenging effort. Oftentimes, when a person is creating an electronic document, an electronic message, or web content they assume the responsibility of creating new digital assets within the document, message, or web content instead of utilizing existing digital assets. Thus, the person's productivity can be improved by leveraging existing digital assets previously created within their organization.

It is known to use repositories (e.g., media libraries) to collect and store digital assets for future use, wherein the digital assets are collected via a manual upload process. For example, an organization can purchase digital assets, such as images and even videos, to manually upload into their repositories. However, searching and retrieving a digital asset from a repository that is contextually relevant within a document being created, can be difficult.

### SUMMARY

Aspects of an embodiment of the present invention disclose a method, computer system, and program product for collecting digital assets to form a searchable repository. A computer identifies a digital asset. The computer extracts a copy of the digital asset to store in a repository. The computer tokenizes plaintext into a grammar, wherein the plaintext is associated with the digital asset. The computer determines if the digital asset is an image, wherein if the digital asset is an image then program code is instructed to identify colors and shapes within the image, and also relationships between the image and other digital assets stored in the repository, and wherein if the digital asset is an image the program code generates parameter values representing the colors, shapes, and relationships identified. The computer generates contextual information corresponding to the digital asset by utilizing the plaintext that is tokenized into the grammar, wherein the contextual information includes the parameter values representing the colors, shapes, and relationships identified. The computer queries the repository to retrieve one or more copies of other digital assets having contextual information that matches with the contextual information corresponding to the digital asset. The computer annotates the copy of the digital asset within the repository to form searchable metadata.

### BRIEF DESCRIPTION OF THE SEVERAL VIEWS OF THE DRAWINGS

The subject matter that is regarded as an embodiment of the present invention is particularly pointed out and distinctly claimed in the claims at the conclusion of the specification. One manner in which recited features of an embodiment of the present invention can be understood is by reference to the following detailed description of embodiments, taken in conjunction with the accompanying drawings in which:

FIG. 1 is a block diagram of a computer system utilizing digital asset management program for extracting, annotating, and cataloging digital assets from electronic documents, electronic messages, and/or web content in an automated fashion to form a searchable asset repository, wherein the digital asset management program includes a digital asset management client module installed on a client computer and a digital asset management server module installed on each server computer according to an embodiment of the present invention.

FIGS. 2A-2B are flowcharts illustrating operations of the digital asset management program according to an embodiment of the present invention.

FIG. 3 is a block diagram depicting internal and external components of the client computer and the server computers of FIG. 1 according to an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Exemplary embodiments now will be described more fully herein with reference to the accompanying drawings. This disclosure may, however, be embodied in many different forms and should not be construed as limited to the exemplary embodiments set forth herein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

Embodiments of the present invention provide a digital asset management program to collect digital assets to form a searchable repository. The digital asset management program extracts, annotates, and catalogs digital assets from electronic documents, electronic messages, and web content to form a searchable asset repository. The digital asset management program includes functionality to interactively populate the asset repository, in an automated fashion, in response to the digital asset management program identifying a new digital asset not already stored in the asset repository. Digital assets stored in the asset repository can be retrieved and utilized by an end-user, which saves time and labor associated with having to recreate new digital assets. As a result, the digital asset management program can increase the productivity and efficiency of the end-user.

Historically, an end-user that is creating a document or presentation assumed the responsibility of creating new digital assets within the document or presentation, or the end-user searched for and purchased existing digital assets from a media library. However, the end-user having to create new digital assets is inefficient. Moreover, current solutions for search and retrieval of digital assets within a media library may not return digital assets that are contextually relevant to a particular document that the end-user is creating, even though one or more digital assets that are contextually relevant and meet the end-user's search criteria are in the media library. In addition, media libraries may have to be manually populated. Thus, in one embodiment of the disclosure there is a need to extract, annotate, and catalog digital assets from electronic documents, electronic messages, and web content in an automated fashion, to form a searchable asset repository that can return one or more digital assets which are contextually relevant to a particular document, based on search criteria provided via a query from an end-user to the asset repository.

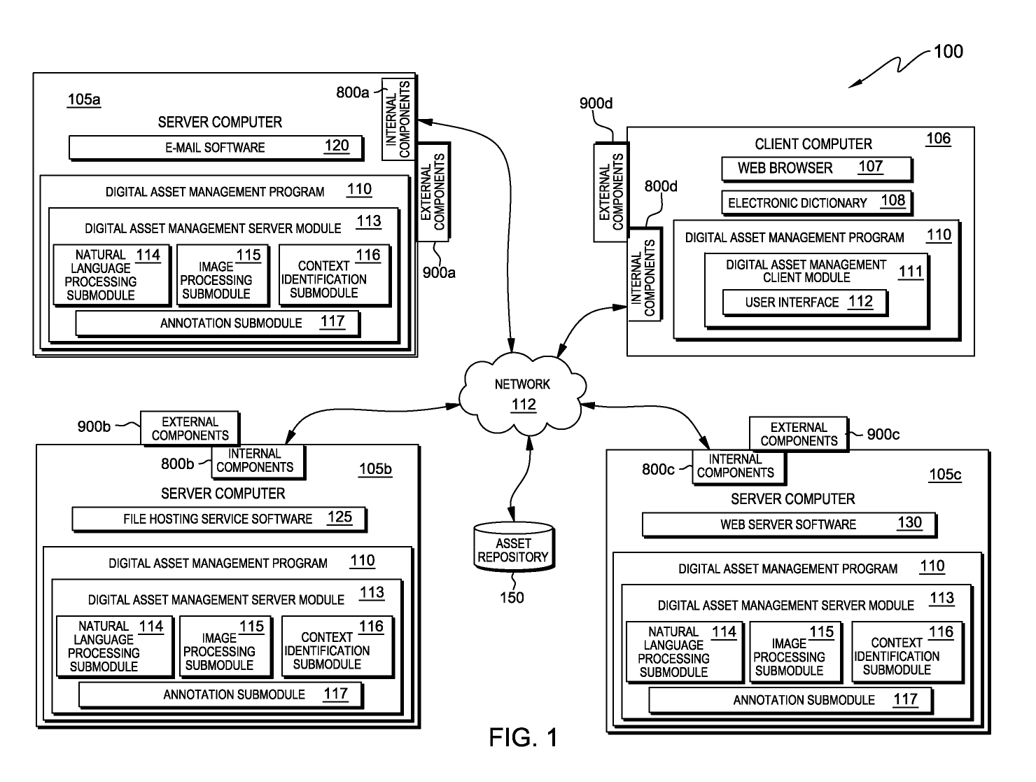

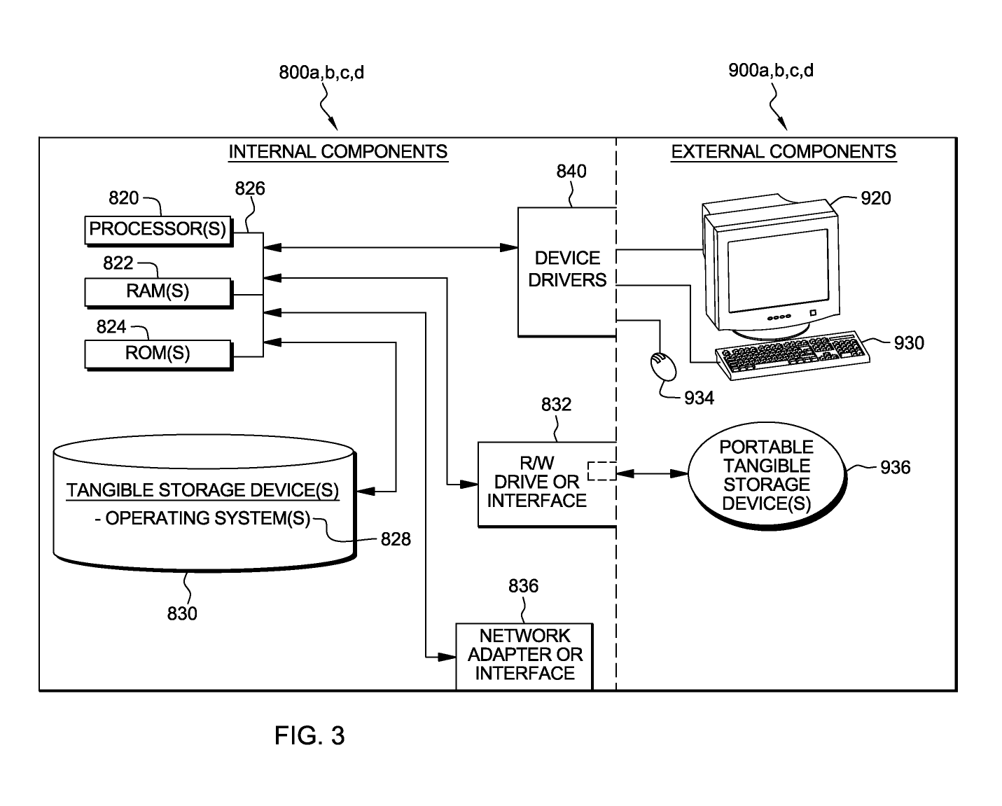

FIG. 1 illustrates computer system 100 that includes server computer 105a-105c, client computer 106, and asset repository 150 all interconnected via network 112. Server computers 105a-105c and client computer 106 each include respective internal components 800a-800c and 800d, and respective external components 900a-900c and 900d, as described below in more detail with respect to FIG. 3. In the disclosed embodiment, only one client computer 106 is shown, but in other embodiments more than one client computer 106 may be interconnected to server computers 105a-105c via network 112.

Digital asset management program 110 that can be utilized to extract, annotate, and catalog digital assets from electronic documents (i.e., files), electronic messages (i.e., electronic mail), and even web content to form a searchable asset repository 150 within computer system 100. Program code for digital asset management program 110 includes digital asset management client module 111 having user interface 112, and digital asset management server module 113 having natural language processing submodule 114, image processing submodule 115, context identification submodule 116, and annotation submodule 117. Digital asset management server module 113 is installed on each server computer 105a-105c, and digital asset management client module 111 is installed on client computer 106. In addition, e-mail software 120, for handling electronic messages sent by an end-user via client computer 106, is installed on server computer 105a. File hosting service software 125, for uploading files accessible by the end-user via client computer 106, is installed on server computer 105b. Moreover, web server software 130, for delivering web content accessible by the end-user via client computer 106, is installed on server computer 105c. Thus, client computer 106 includes web browser 107 for an end-user to access electronic mail (e-mail) handled by server computer 105a, access files hosted by server computer 105b, and access web content (e.g., a wiki) delivered by server computer 105c. Client computer 106 further includes electronic dictionary 108 that can be utilized by digital asset management program 110 to search for and identify digital assets within an e-mail, a file, or web content.

As mentioned above, digital asset management server module 113 includes natural language processing submodule 114, image processing submodule 115, context identification submodule 116, and annotation submodule 117. Natural language processing submodule 114 is utilized to derive meaning from plaintext that is associated with digital assets (e.g., images, diagrams, flowcharts, video, and audio) extracted from an e-mail, a file, or a web content (e.g., a wiki). Specifically, natural language processing submodule 114 can derive meaning from plaintext by identifying certain information (e.g., specific words, phrases, and patterns) within plaintext of the e-mail, the file, or the web content.

In the disclosed embodiment, natural language submodule 114 includes additional functionality for parsing the plaintext into tokens (i.e., tokenizing the plaintext), deriving an intended semantic, performing one or more word sense disambiguation, and named-entity recognition. For example, an end-user may send an e-mail, via web browser 107, that states “we will be having a meeting to discuss the attached figures to finalize how we plan to configure and deploy the new software system from an architectural standpoint, and the meeting will take place in Watson 523 tomorrow from 9:00 am-11:00 am.” In response to server computer 105a receiving the e-mail, natural language processing submodule 114 parses the e-mail. Based on the parsing, natural language processing submodule 114 can identify that the e-mail includes dates such as tomorrow, times such as 9:00 am-11:00 am, a meeting room location such as Watson 523, and that the e-mail may even contain a file with images and/or other digital assets. Natural language processing submodule 114 can also perform vector-based semantic analysis to determine similarity between current plaintext associated with a digital asset and plaintext previously processed and associated as metadata to other digital assets in asset repository 150. Moreover, natural language processing submodule 114 includes functionality that can perform word recognition, spellchecking, and anaphora resolution on plaintext that is associated with digital assets to further identify information and derive meaning from the plaintext.

In addition to natural language processing submodule 114 identifying information, as mentioned above, image processing submodule 115 can be utilized to derive meaning from digital assets that are images identified within an e-mail, a file, or web content. In particular, image processing submodule 115 can identify objects within digital assets that are images, and identify other similar digital assets that are images in asset repository 150. Moreover, to derive meaning from the digital assets that are images, image processing submodule 115 can use a machine learning algorithm that takes a set of objects as input, and provides as output a confidence score, wherein each confidence score corresponds to a pre-defined meaning that can be configured by a system programmer/administrator. Furthermore, image processing submodule 115 includes functionality for identifying colors and shapes within the digital assets that are images, generating parameter values representing the colors identified, and generating parameter values representing the shapes identified. In the disclosed embodiment, the parameter values representing the shapes identified can be a list of objects identified in the digital assets that are images.

Program code for digital asset management program 110 can extract a copy of each of the digital assets, and store the copy of each of the digital assets in asset repository 150. The program code for digital asset management program 110 can also store in asset repository 150 one or more digital license certificates associated to the copy of each of the digital assets identified within the e-mail, file, or web content. In addition, program code for digital asset management program 110 further includes functionality for identifying each relationship (e.g., lineage), if any, between digital assets identified (e.g., images) in an e-mail, file, or wiki, and existing digital assets stored in asset repository 150. For example, a lineage can arise from an end-user cropping a source image (i.e., an original created image), wherein the cropping creates a subset of the source image and the lineage represents a relationship between the source image and the subset of the source image. In addition, the subset of the source image may be subsequently cropped again to create a sub-subset of the source image and thereby give rise to another lineage that represents a relationship between the subset of the source image and the sub-subset of the source image. Even additional lineages can arise in the same manner as described above. Thus, if the program code for digital asset management program 110 (e.g., image processing submodule 115) identifies a relationship between images, then the program code for digital asset management program 110 generates one or more parameter values representing the relationship. The images mentioned above can be in various image file formats such as the following: BMP, GIF, JPEG, PNG, TIFF, etc.

Subsequently, context identification submodule 116 interacts with annotation submodule 117 to aggregate and store as metadata that is searchable, in asset repository 150, at least the following: the information identified by natural language processing submodule 114, the parameter values generated representing colors identified in the images, the parameter values generated representing the shapes identified in the images, the parameter values generated representing the relationships identified between the digital assets, and digital license certificates associated to the copy of each of the digital assets.

In one embodiment, annotation submodule 117 stores the metadata in asset repository 150 within a database table, wherein annotation submodule 117 associates the metadata to digital assets (e.g., images, copies of digital assets) within asset repository 150, and wherein program code for digital asset management program 110 catalogs the digital assets. However, in other embodiments, the metadata may be stored on server computers 105a-105c by utilizing simple plaintext files, delimiter based files, XML files, or other in-memory structured/semi-structured documents or even data structures. For example, in the other embodiments, the metadata may be implemented utilizing a data structure having pointers (i.e., addresses) to one or more other data structures, wherein each of the data structures represent metadata associated to a digital asset (e.g., an image) and each of the pointers represents a relationship (e.g., lineage) between two digital assets.

Accordingly, asset repository 150 stores a copy of each of the digital assets extracted from an e-mail, a file, or web content along with respective metadata associated to the digital assets. The digital assets extracted from the e-mail, file, or web content can be cataloged by the program code. Moreover, an end-user can submit a query, via user interface 112, to asset repository 150 to retrieve the copy of each of the digital assets having metadata that matches with search criteria specified in the query. Thus, if the query submitted by the end-user has search criteria that matches with metadata within asset repository 150, then in response to the query asset repository 150 returns the copy of each of the digital assets associated to the metadata that matches with the search criteria. The end-user may utilize the copy of each of the digital assets (e.g., copy of the images) returned to include in a document or presentation he or she is working on, which can help the end-user avoid time wasted in recreating new images.

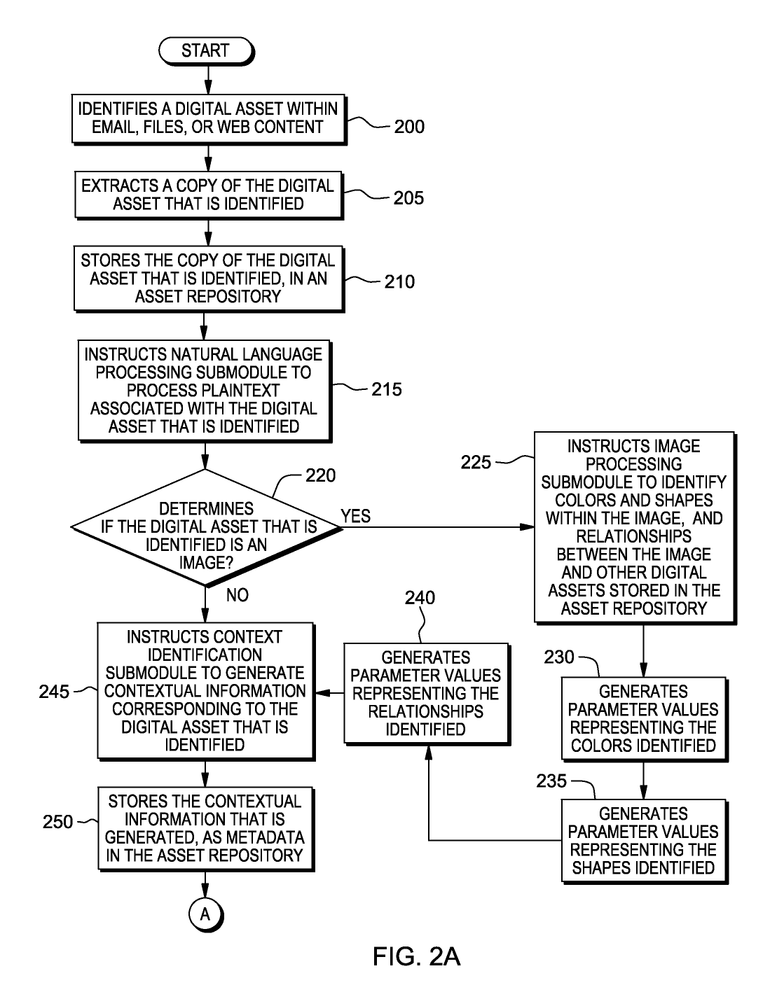

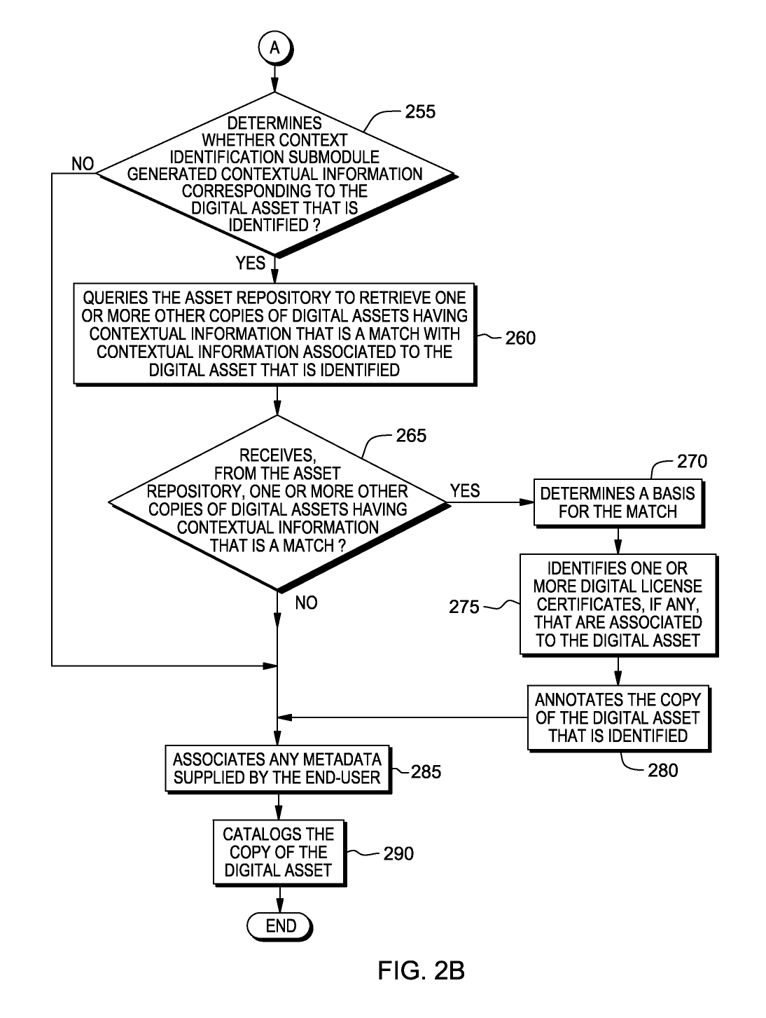

FIGS. 2A-2B are flowcharts illustrating operations of digital asset management program 110 for extracting, annotating, and cataloging a digital asset (i.e., image, diagram, flowchart, video, and audio) from electronic messages, electronic documents, and/or web content in an automated fashion to form a searchable asset repository 150. Digital asset management program 110 can be configured to interact with e-mail software 120 (e.g., IBM Lotus Notes®), file hosting service software 125 (e.g., IBM Lotus® Quickr®), and even web server software 130 (e.g., IBM HTTP Server, Lotus® Domino®) to extract, annotate, and catalog the digital asset. Specifically, digital asset management program 110 can be configured to have digital asset management server module 113 monitor e-mail software 120 for newly sent electronic messages, monitor file hosting service software 125 for newly uploaded files, and monitor web server software 130 for newly posted web content.

In the disclosed embodiment, an end-user is utilizing web browser 107 to send an e-mail, upload files, and post web content to inform colleagues about an upcoming meeting to discuss a plan to implement and deploy a new digital asset management software system. The e-mail says the following: “We will be having a meeting to discuss the attached figures to finalize our plan to configure and deploy the new digital asset management software system from an architectural standpoint, and the meeting will take place in room Amabo44 on Tuesday from 2:00 pm-3:30 pm. Files with additional presentation materials have been uploaded to our team's designated file hosting server, and web content having flowcharts and audio files explaining the flowcharts have been posted on a wiki. The URL link to the wiki is below.”

The end-user, via web browser 107, sends the e-mail, uploads the files with the additional presentation material, and posts the web content having the flowcharts and the audio files. The e-mail is transmitted to and received by server computer 105a, the files with the additional presentation materials are transmitted to and received by server computer 105b, and the web content having the flowcharts and the audio files is transmitted to and received by server computer 105c. In response to server computer 105a receiving the e-mail, server computer 105b receiving the files with the additional presentation materials, or server computer 105c receiving the web content having the flowcharts and the audio files, digital asset management program 110 is configured to interact with e-mail software 120, file hosting service software 125, and web server software 130 to identify a digital asset within the e-mail, files, or web content received by respective server computers 105a-105c.

Particularly, in the disclosed embodiment, the e-mail received by server computer 105a has attached figures, the files received by server computer 105b have additional presentation materials, and the web content received by server computer 105c has flowcharts and audio files. In response, to server computers 105a, 105b, and 105c receiving the e-mail, files, and web content respectively, digital asset management server module 110 identifies a digital asset within the e-mail, files, or web content (block 200). Moreover, digital asset management server module 110 can identify more than one digital asset.

To identify the digital asset, digital asset management server module 110 searches for an image, a diagram, a flowchart, a video, and even audio within the e-mail that is sent, files that are uploaded, and web content that is posted. For example, digital asset management program 110 can identify the digital asset by searching among e-mail, uploaded files, and web content for files having a filename with one or more words, phrases, or acronyms that match words or acronyms within a configurable list, wherein the words or acronyms within the configurable list are typically associated with a digital asset. Some words or acronyms typically associated with a digital asset include: audio, chart, diagram, flowchart, photo, pic, picture, video, and vid. In the disclosed embodiment, the configurable list is electronic dictionary 108. Electronic dictionary 108 resides on client computer 106, and can be updated by a system programmer/administrator. In other embodiments, electronic dictionary 108 can also reside on each of server computers 105a-105c. In addition, digital asset management program 110 can also identify the digital asset by searching among e-mail, uploaded files, and web content for files having the following file extensions: BMP, GIF, JPEG, PNG, TIFF, MP3, MPG, MOV, WAV, WMA, or other file extensions based on design requirements.

Subsequent to identifying the digital asset, digital asset management program 110 extracts a copy of the digital asset that is identified within the e-mail, files, or web content (block 205). Digital asset management program 110 stores the copy of the digital asset that is identified, in asset repository 150 (block 210). The copy of the digital asset that is identified can include one or more digital license certificates that are associated to the digital asset. Next, digital asset management program 110 instructs natural language processing submodule 114 to process plaintext, if any, associated with the digital asset that is identified (block 215). Therefore, if the digital asset that is identified includes plaintext, then natural language processing submodule 114 will process the plaintext. One purpose of natural language processing submodule 114 is to derive meaning from the plaintext associated with the digital asset. The meaning derived from the plaintext associated with the digital asset can be utilized to annotate the digital asset, and even catalog the digital asset within asset repository 150. Specifically, to derive meaning from the plaintext associated with the digital asset natural language processing submodule 114 tokenizes the plaintext into a grammar that natural language processing submodule 114 can interpret. Based on the tokenized text, natural language processing submodule 114 can identify certain information (e.g., specific words, phrases, and patterns) within plaintext associated with the digital asset. In addition, natural language processing submodule 114 sends the tokenized plaintext as input to context identification submodule 116 and annotation submodule 117. Thus, the tokenized plaintext can be utilized to generate contextual information corresponding to the digital asset and also to annotate the digital asset, as discussed in more detail below.

Subsequent to processing the plaintext associated with the digital asset, digital asset management program 110 determines if the digital asset that is identified is an image (decision block 220). If the digital asset that is identified is not an image (the “NO” branch of decision block 220), then digital asset management program 110 instructs context identification submodule 116 to generate contextual information corresponding to the digital asset that is identified (block 245). Specifically, to generate the contextual information, context identification submodule 116 receives the tokenized plaintext from natural language processing submodule 114, and performs any number of word sense disambiguation, named-entity recognition, anaphora resolution, and vector-based semantic analysis on the tokenized plaintext. For example, context identification submodule 116 can determine from a sentence having the phrase “illustrated in the attached diagram” that the reference to ‘attached diagram’ refers to the digital asset that is identified and that contents of the asset may be explained by plaintext surrounding the phrase.

Otherwise, if the digital asset that is identified is an image (the “YES” branch of decision block 220), then digital asset management program 110 instructs image processing submodule 115 to identify colors and shapes within the image, and relationships between the image and other digital assets stored in asset repository 150 (block 225). Image processing submodule 115 includes program code that can identify colors within the image by performing measurements that quantify the intensity of each of the colors. In other embodiments, image processing submodule 115 can identify colors by utilizing software libraries having program code that opens a digital asset that is an image and obtains pixel values of the image.

Image processing submodule 115 can identify shapes within the image by overlaying predefined shapes on the image and computing the percentage of overlap. The predefined shapes can be stored on a suitable computer readable tangible storage device (e.g., asset repository 150) connected to server computers 105a-105c. For example, the predefined shape may be a rectangle having rounded corners or even a cylinder, wherein a system programmer/administrator can associate to the predefined shape textual information about how digital assets having the predefined shape is typically used. Thus, if the rectangle with rounded corners is overlayed on an image of a cell phone extracted from the e-mail, file, or web content and the percentage of overlap that is computed satisfies a configurable threshold, then image processing submodule 115 outputs the textual information about how the digital assets having the predefined shape is typically used. In addition, image processing submodule 115 can identify shapes and even similarities between the digital assets that are images by dividing each of the images into subsections, and based on the subsections generating hash values corresponding to each of the images. The hash values that are generated can be utilized to perform comparisons with hash values of other images in asset repository 150 in order to determine similarities between the images. Thus, image processing submodule 115 can determine similarities between the copy of the digital asset that is identified and other digital assets in asset repository 150.

Furthermore, image processing submodule 115 can identify each relationship (i.e., lineage), if any, between the image and existing digital assets stored in asset repository 150. As mentioned above, a lineage can arise from an end-user cropping a source image (i.e., an original created image), wherein the cropping creates a subset of the source image and the lineage represents a relationship between the source image and the subset of the source image.

Subsequent to identifying the colors and shapes within the image as well as the relationships (i.e., lineages) of the image, image processing submodule 115 generates parameter values representing the colors identified (block 230), generates parameter values representing the shapes identified (block 235), and generates parameter values representing the relationships identified (block 240). The parameter values generated are also outputted from image processing submodule 115. Specifically, image processing submodule 115 utilizes the measurements that quantify the intensity of each of the colors to generate and output parameter values representing the colors identified, utilizes blob detection to generate and output the parameter values representing the shapes identified, and utilizes contextual information previously generated and the output from the blob detection to generate the parameter values representing the relationships identified.

Next, digital asset management program 110 instructs context identification submodule 116 to generate contextual information corresponding to the digital asset that is identified (block 245). If the digital asset is an image and the image is associated with plaintext (e.g., image has surrounding text), then context identification submodule 116 not only utilizes the tokenized plaintext from natural language processing submodule 114 to generate the contextual information, but also the textual information outputted from image processing submodule 115 to generate the contextual information. Context identification submodule 116 stores the contextual information that is generated, as metadata in asset repository 150 (block 250). The metadata is searchable by an end-user, and can be attached (i.e., associated to) the digital assets in asset repository 150. Thus, within asset repository 150, the copy of the digital asset that is identified is stored along with the contextual information that is generated, which can enhance search and retrieval of digital assets in asset repository 150.

As used herein, contextual information refers to information that can be utilized to gain an understanding of plaintext that may be associated to a digital asset. As mentioned above, contextual information can include at least the following: the information identified by natural language processing submodule 114, the parameter values generated representing colors identified in the images, the parameter values generated representing the shapes identified in the images, and the parameter values generated representing the relationships identified.

Next, digital asset management program 110 instructs annotation submodule 117 to annotate the copy of the digital asset extracted by digital asset management program 110. To annotate the copy of the digital asset, annotation submodule 117 determines whether context identification submodule 116 generated contextual information corresponding to the digital asset that is identified (decision block 255).

If annotation submodule 117 determines that context identification submodule 116 did not generate contextual information corresponding to the digital asset that is identified (the “NO” branch of decision block 255), then annotation submodule 117, to perform annotations, associates any metadata supplied by an end-user to the copy of the digital asset that is identified (block 285). Specifically, to perform the above annotations, annotation submodule 117 generates a database table within asset repository 150 to store the metadata supplied by the end-user, and associates the database table to the copy of the digital asset that is identified.

Otherwise, if annotation submodule 117 determines that context identification submodule 116 generated contextual information corresponding to the digital asset that is identified (the “YES” branch of decision block 255), then annotation submodule 117 queries asset repository 150 to retrieve one or more other copies of digital assets having contextual information that is a match with contextual information associated to the copy of the digital asset that is identified (block 260).

In response to the query, if annotation submodule 117 does not receive, from asset repository 150, one or more other copies of digital assets having contextual information that is a match with contextual information associated to the copy of the digital asset that is identified (the “NO” branch of decision block 265), then annotation submodule 117 associates any metadata supplied by an end-user to the copy of the digital asset that is identified (block 285). Otherwise, if annotation submodule 117 receives, from asset repository 150, one or more other copies of digital assets having contextual information that is a match with contextual information associated to the copy of the digital asset that is identified (the “YES” branch of decision block 265), then annotation submodule 117 determines a basis for the match (block 270). The basis for the match can include whether the digital assets were used in a similar context and whether the digital assets are associated through any relationship (e.g., lineage). Next, annotation submodule 117 identifies one or more digital license certificates, if any, that are associated to the digital asset (block 275). The one or more digital license certificates defines permissible uses of the digital asset identified, and prevents end-users from performing unauthorized actions with the digital asset (e.g., copying, cutting, pasting, and/or sending the digital asset).

Furthermore, annotation submodule 117 interacts with natural language processing submodule 114, image processing submodule 115, and context identification submodule 116 to annotate the copy of the digital asset that is identified (block 280). In particular, annotation submodule 117 performs the following annotations: associates a context as metadata attached to the copy of the digital asset that is identified, associates a topic as metadata attached to the copy of the digital asset that is identified, associates one or more relationships (e.g., a common usage of the digital asset by an end-user) as metadata attached to the copy of the digital asset that is identified, associates license information as metadata attached to the copy of the digital asset that is identified, associates source information as metadata attached to the copy of the digital asset that is identified, associates a lineage to the copy of the digital asset that identified, and associates one or more tags as metadata attached to the copy of the digital asset that identified.

Specifically, to perform the above annotations, annotation submodule 117 generates a database table within asset repository 150 to store the attached metadata and the lineage mentioned above, and associates the database table to the copy of the digital asset that is identified. The context, topic, relationships, license information, source information, lineage, and tags mentioned above are generated by utilizing contextual information from context identification submodule 116.

In particular, the context that is associated with the copy of the digital asset is generated by processing the tokenized plaintext and performing any number of iterations of NLP processing to find normalized values, and interpretations of keywords and named entity recognition. The topic that is associated with the copy of the digital asset refers to a generalized category the digital asset would be associated with, and is generated by comparing metadata associated to the copy of the digital asset with existing digital assets in the repository. The relationships that are associated with the copy of the digital asset refer to lineage as well as topics or objects identified within the digital asset, and are generated by processing the metadata associated to the digital asset. Specifically, the lineage that is associated with the copy of the digital asset is generated by comparing the digital assets to identify a unique attribute within the digital assets that exist in other digital assets, wherein the lineage is assigned based on the first digital asset identified having the unique attribute.

Furthermore, the license information that is associated to the copy of the digital asset is generated from the one or more digital license certificates identified by annotation submodule 117. The source information that is associated with the copy of the digital asset refers to information related to where the digital asset came from, and is generated by determining the oldest related digital asset via lineage or through determining an origin or a license associated to the digital asset. Moreover, the tags that are associated with the copy of the digital asset can refer to a variety of additional information, and are generated by an end-user that initiated digital asset management program 110.

Next, annotation submodule 117 performs additional annotations in which annotation submodule 117 associates any metadata supplied by an end-user to the copy of the digital asset that is identified (block 285). To perform the additional annotations, annotation submodule 117 generates a database table within asset repository 150 to store the metadata supplied by the end-user, and associates the database table to the copy of the digital asset that is identified.

Subsequently, digital asset management server module 113 catalogs the copy of the digital asset by arranging all the metadata into a searchable format stored in repository 150 (e.g., a relational database), and digital asset management program 110 ends (block 290). As a result, the cataloged digital assets are available in asset repository 150 for end-users to access and retrieve. The digital assets that are retrieved can be shared among the end-users as permitted, based on the digital license certificates that define permissible uses.

FIG. 3 is a block diagram depicting a set of internal components 800a-800c and a set of external components 900a-900c that correspond to respective servers computer 105a-105c, as well as a set of internal components 800d and a set of external components 900d that correspond to client computer 106. Internal components 800a-800d each include one or more processors 820, one or more computer readable RAMs 822 and one or more computer readable ROMs 824 on one or more buses 826, and one or more operating systems 828 and one or more computer readable tangible storage devices 830. The one or more operating systems 828 and digital asset management server module 113 of digital asset management program 110 on each server computer 105a-105c; and digital asset management client module 111 of digital asset management program 110 on client computer 106 are stored on one or more of the respective computer readable tangible storage devices 830 for execution by one or more of the respective processors 820 via one or more of the respective RAMs 822 (which typically include cache memory). In the embodiment illustrated in FIG. 3, each of the computer readable tangible storage devices 830 is a magnetic disk storage device of an internal hard drive. Alternatively, each of the computer readable tangible storage devices 830 is a semiconductor storage device such as ROM 824, EPROM, flash memory or any other computer readable tangible storage device that can store a computer program and digital information.

Each set of internal components 800a-800d includes a R/W drive or interface 832 to read from and write to one or more portable computer readable tangible storage devices 936 such as CD-ROM, DVD, memory stick, magnetic tape, magnetic disk, optical disk or semiconductor storage device. Digital asset management server module 113 on each server computer 105a-105c; and digital asset management client module 111 on client computer 106 can be stored on one or more of the respective portable computer readable tangible storage devices 936, read via the respective R/W drive or interface 832 and loaded into the respective hard drive or computer readable tangible storage device 830.

Furthermore, each set of internal components 800a-800d also includes a network adapter or interface 836 such as TCP/IP adapter card, wireless wi-fi interface card, or 3G or 4G wireless interface card or other wired or wireless communication link. Digital asset management server module 113 on each server computer 105a-105c; and digital asset management client module 111 on client computer 106 can be downloaded to respective server computers 105a-105c and respective client computer 106 from an external computer or external storage device via a network (for example, the Internet, a LAN, or a WAN) and respective network adapters or interfaces 836. From the network adapter or interface 836, digital asset management server module 113 on each server computer 105a-105c; and digital asset management client module 111 on client computer 106 are loaded into at least one respective hard drive or computer readable tangible storage device 830. The network may comprise copper wires, optical fibers, wireless transmission, routers, firewalls, switches, gateway computers and/or servers.

Each set of external components 900a-900d can include a computer display monitor 920, a keyboard 930, and a computer mouse 934. External components 900a-900d can also include touch screens, virtual keyboards, touch pads, pointing devices, and other human interface devices. Each set of internal components 800a-800d also includes device drivers 840 to interface to computer display monitor 920, keyboard 930 and computer mouse 934. The device drivers 840, R/W drive or interface 832 and network adapter or interface 836 comprise hardware and software in which the software is stored in computer readable tangible storage device 830 and/or ROM 824.

It should be appreciated that FIG. 3 provides only an illustration of one implementation and does not imply any limitations with regard to the environments in which different embodiments may be implemented. A variety of modifications to the depicted environments may be implemented. Moreover, a variety of modifications to the depicted environments may be made based on design and implementation requirements.

In accordance with the foregoing, a method, a computer system, and a computer program product have been disclosed for extracting, annotating, and cataloging digital assets from electronic documents, electronic messages, and web content in an automated fashion to form a searchable asset repository. However, numerous modifications and substitutions can be made without deviating from the scope of an embodiment of the invention. Therefore, one or more embodiments of the invention have been disclosed by way of example and not limitation.

What is claimed is:

1. A computer implemented method for collecting digital assets to form a searchable repository, the method comprising the steps of:
identifying a digital asset;
extracting a copy of the digital asset to store in a repository;
tokenizing plaintext into a grammar, wherein the plaintext is associated with the digital asset;
determining if the digital asset is an image, wherein if the digital asset is an image then program code is instructed to identify colors and shapes within the image, and also relationships between the image and other digital assets stored in the repository, and wherein if the digital asset is an image the program code generates parameter values representing the colors, shapes, and relationships identified;
generating contextual information corresponding to the digital asset by utilizing the plaintext that is tokenized into the grammar, wherein the contextual information includes the parameter values representing the colors, shapes, and relationships identified;
querying the repository to retrieve one or more copies of other digital assets having contextual information that matches with the contextual information corresponding to the digital asset; and
annotating the copy of the digital asset within the repository to form searchable metadata.

2. The method of claim 1, wherein the digital asset that is identified is an image, a diagram, a flowchart, a video, or audio within e-mail that is sent to a recipient, within files that are uploaded to a file hosting server, or even within web content that is posted to a wiki.

3. The method of claim 1, wherein the program code identifies colors within the image by performing measurements that quantify an intensity of each of the colors, or by utilizing software libraries having program code that opens the image and obtains pixel values of the image.

4. The method of claim 1, wherein the program code identifies shapes within the image by overlaying predefined shapes on the image and computing a percentage of overlap, or by dividing the image into a plurality of subsections, and based on the subsections generating hash values that correspond to the image wherein the hash values that are generated are utilized to perform comparisons with other hash values corresponding to other images in the repository.

5. The method of claim 1, wherein the step of generating the contextual information comprises executing word sense disambiguation, named-entity recognition, anaphora resolution, and vector-based semantic analysis on the plaintext that is tokenized, and wherein contextual information includes the following: words, phrases, and patterns identified within the plaintext, the parameter values generated representing colors, shapes, and relationships identified.

6. The method of claim 1, wherein the step of annotating the copy of the digital asset within the repository to form searchable metadata comprises: associating a context, a topic, a relationship, license information, source information, and a tag as metadata attached to the copy of the digital asset; associating any metadata supplied by an end-user to the copy of the digital asset; generating a database table, within the repository, to store the metadata that is attached, lineage, and the metadata supplied by the end-user; and associating the database table to the copy of the digital asset.

7. A computer program product for collecting digital assets to form a searchable repository, the computer program product comprising:
a computer readable storage medium and program instructions stored on the computer readable storage medium, the program instructions comprising:
program instructions to identify a digital asset;
program instructions to extract a copy of the digital asset to store in a repository;
program instructions to tokenize plaintext into a grammar, wherein the plaintext is associated with the digital asset;
program instructions to determine if the digital asset is an image, wherein if the digital asset is an image then program code is instructed to identify colors and shapes within the image, and also relationships between the image and other digital assets stored in the repository, and wherein if the digital asset is an image the program code generates parameter values representing the colors, shapes, and relationships identified;
program instructions to generate contextual information corresponding to the digital asset by utilizing the plaintext that is tokenized into the grammar, wherein the contextual information includes the parameter values representing the colors, shapes, and relationships identified;
program instructions to query the repository to retrieve one or more copies of other digital assets having contextual information that matches with the contextual information corresponding to the digital asset; and
program instructions to annotate the copy of the digital asset within the repository to form searchable metadata.

8. The computer program product of claim 7, wherein the digital asset that is identified is an image, a diagram, a flowchart, a video, or audio within e-mail that is sent to a recipient, within files that are uploaded to a file hosting server, or even within web content that is posted to a wiki.

9. The computer program product of claim 7, wherein the program code identifies colors within the image by performing measurements that quantify an intensity of each of the colors, or by utilizing software libraries having program code that opens the image and obtains pixel values of the image.

10. The computer program product of claim 7, wherein the program code identifies shapes within the image by overlaying predefined shapes on the image and computing a percentage of overlap, or by dividing the image into a plurality of subsections, and based on the subsections generating hash values that correspond to the image wherein the hash values that are generated are utilized to perform comparisons with other hash values corresponding to other images in the repository.

11. The computer program product of claim 7, wherein the step of generating the contextual information comprises executing word sense disambiguation, named-entity recognition, anaphora resolution, and vector-based semantic analysis on the plaintext that is tokenized, and wherein contextual information includes the following: words, phrases, and patterns identified within the plaintext, the parameter values generated representing colors, shapes, and relationships identified.

12. The computer program product of claim 7, wherein the step of annotating the copy of the digital asset within the repository to form searchable metadata comprises: associating a context, a topic, a relationship, license information, source information, and a tag as metadata attached to the copy of the digital asset; associating any metadata supplied by an end-user to the copy of the digital asset; generating a database table, within the repository, to store the metadata that is attached, lineage, and the metadata supplied by the end-user; and associating the database table to the copy of the digital asset.

13. A computer system for collecting digital assets to form a searchable repository, the computer system comprising:
one or more processors, one or more computer readable memories, one or more computer readable storage media, and program instructions stored on the one or more storage media for execution by the one or more processors via the one or more memories, the program instructions comprising:
program instructions to identify a digital asset;
program instructions to extract a copy of the digital asset to store in a repository;
program instructions to tokenize plaintext into a grammar, wherein the plaintext is associated with the digital asset;
program instructions to determine if the digital asset is an image, wherein if the digital asset is an image then program code is instructed to identify colors and shapes within the image, and also relationships between the image and other digital assets stored in the repository, and wherein if the digital asset is an image the program code generates parameter values representing the colors, shapes, and relationships identified;
program instructions to generate contextual information corresponding to the digital asset by utilizing the plaintext that is tokenized into the grammar, wherein the contextual information includes the parameter values representing the colors, shapes, and relationships identified;
program instructions to query the repository to retrieve one or more copies of other digital assets having contextual information that matches with the contextual information corresponding to the digital asset; and
program instructions to annotate the copy of the digital asset within the repository to form searchable metadata.

14. The computer system of claim 13, wherein the digital asset that is identified is an image, a diagram, a flowchart, a video, or audio within e-mail that is sent to a recipient, within files that are uploaded to a file hosting server, or even within web content that is posted to a wiki.

15. The computer system of claim 13, wherein the program code identifies colors within the image by performing measurements that quantify an intensity of each of the colors, or by utilizing software libraries having program code that opens the image and obtains pixel values of the image.

16. The computer system of claim 13, wherein the program code identifies shapes within the image by overlaying predefined shapes on the image and computing a percentage of overlap, or by dividing the image into a plurality of subsections, and based on the subsections generating hash values that correspond to the image wherein the hash values that are generated are utilized to perform comparisons with other hash values corresponding to other images in the repository.

17. The computer system of claim 13, wherein the step of generating the contextual information comprises executing word sense disambiguation, named-entity recognition, anaphora resolution, and vector-based semantic analysis on the plaintext that is tokenized, and wherein contextual information includes the following: words, phrases, and patterns identified within the plaintext, the parameter values generated representing colors, shapes, and relationships identified.

18. The computer system of claim 13, wherein the step of annotating the copy of the digital asset within the repository to form searchable metadata comprises: associating a context, a topic, a relationship, license information, source information, and a tag as metadata attached to the copy of the digital asset; associating any metadata supplied by an end-user to the copy of the digital asset; generating a database table, within the repository, to store the metadata that is attached, lineage, and the metadata supplied by the end-user; and associating the database table to the copy of the digital asset.
